(19) United States
(12) Patent Application Publication
(10) Pub. No.: US 2025/0368279 A1
(43) Pub. Date: Dec. 4, 2025

(54) TRAILER BRACKET ASSEMBLY

(71) Applicant: American Trailer World Corp., Addison, TX (US)

(72) Inventor: Josh Rogers, Paris, TX (US)

(21) Appl. No.: 18/677,304

(22) Filed: May 29, 2024

(51) Int. Cl. B62D 33/033; B62D 33/02

(52) U.S. Cl. CPC B62D 33/033; B62D 33/0207

(57) ABSTRACT

A trailer comprising a side panel and a mount secured to the side panel. The mount presents a channel void extending between the mount and the side panel. The trailer further comprises a bracket assembly removably secured to the mount. The bracket assembly comprises a first portion and a second portion releasably connected together by a connection element. The bracket assembly is configured to permit a support element to be secured thereto such that the support element extends above and adjacent to a top surface of the side panel.

### FIELD

Embodiments of the present invention are generally directed to trailers and bracket assemblies for trailers. More particularly, embodiments of the present invention are directed to bracket assemblies that can be efficiently used to removably secure support elements to trailers.

### RELATED ART

Trailers are commonly used in conjunction with vehicles to transport payloads. Often, it can be beneficial to add support elements, such as elongated wooden boards, onto the top of the trailer to act as additional supports. Such additional supports may be used to ensure payloads are securely maintained within the trailer during transport. Certain trailers are known to incorporate mounting mechanisms that are permanently affixed to the trailers (e.g., via weld) and can be used to secure support elements to the trailers. However, it would be beneficial if there existed a mounting mechanism that was removable and/or adjustable, such that the mounting mechanism could be selectively removed from a trailer and that could be used on trailers (or trailer components) of various configurations and sizes.

### SUMMARY

To address the above-described challenges, embodiments of the present invention provide a trailer comprising one or more bracket assemblies that can be removably attached to the trailer. Once such bracket assemblies are attached to the trailer, support elements can be mounted to the trailer via the bracket assemblies.

In more detail, embodiments of the present invention include a trailer comprising a base and a mount secured to the side panel. The mount presents a channel void extending between the mount and the side panel. The trailer further comprises a bracket assembly removably secured to the mount. The bracket assembly comprises a first portion and a second portion releasably connected together by a connection element. The bracket assembly is configured to permit a support element to be secured thereto such that the support element extends adjacent to a top of the side panel.

Embodiments of the present invention additionally include a bracket assembly for a trailer. The bracket assembly comprises a first portion comprising a base plate and a flange plate extending perpendicular to the base plate. The bracket assembly additionally comprises a second portion comprising a base plate and a pair of flange plates that extend from ends of the base plate perpendicular to the base plate. The bracket assembly further comprises a connection element configured to extend between and connect the first portion and the second portion. The flange element of the first portion of the bracket assembly is configured to permit a support element to be secured thereto.

Embodiment of the present invention further include a method of mounting a support element to a trailer. The method comprises a number of steps. One step includes providing the trailer comprising a base and a mount secured to the side panel. The mount presents a channel void extending between the mount and the side panel. An additional step includes removably securing a bracket assembly to the mount. The bracket assembly comprises a first portion and a second portion releasably connected together by a connection element. A further step includes securing the support element to the bracket assembly such that the support element extends adjacent to an upper edge of the side panel.

This summary is not intended to identify essential features of the present invention, and is not intended to be used to limit the scope of the claims. These and other aspects of the present invention are described below in greater detail.

### BRIEF DESCRIPTION OF THE DRAWINGS

Embodiments of the present invention are described in detail below with reference to the attached drawing figures, wherein:

FIG. 1 is a front perspective view of a trailer with a plurality of bracket assemblies according to embodiments of the present invention;

FIG. 2 is a rear perspective view of the trailer with bracket assemblies from FIG. 1;

FIG. 3 is an enlarged view of a portion of the trailer from FIGS. 1 and 2, particularly illustrating one of the bracket assemblies attached to a mount of the trailer;

FIG. 4 is front perspective view of the trailer and bracket assemblies from FIG. 1, with a left side support element and portions of the bracket assemblies separated from the rest of the trailer;

FIG. 5 is an enlarged view of a portion of the trailer from FIG. 4, particularly illustrating one of the bracket assemblies and a portion of the support element separated from the rest of the trailer; and

FIG. 6 is an exploded view of a bracket assembly according to embodiments of the present invention and a portion of a support element;

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

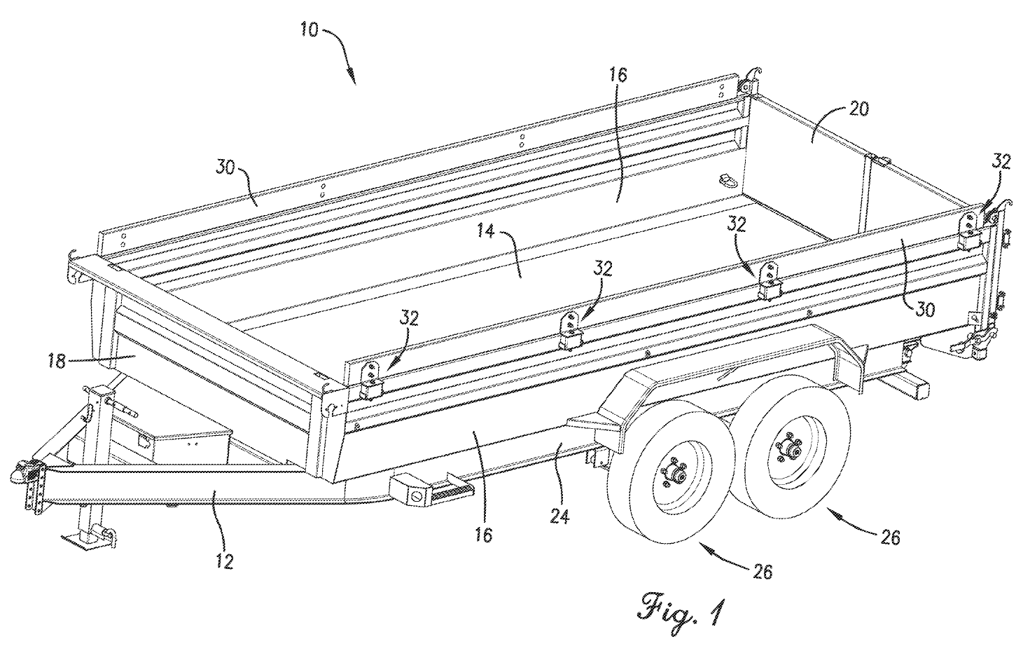

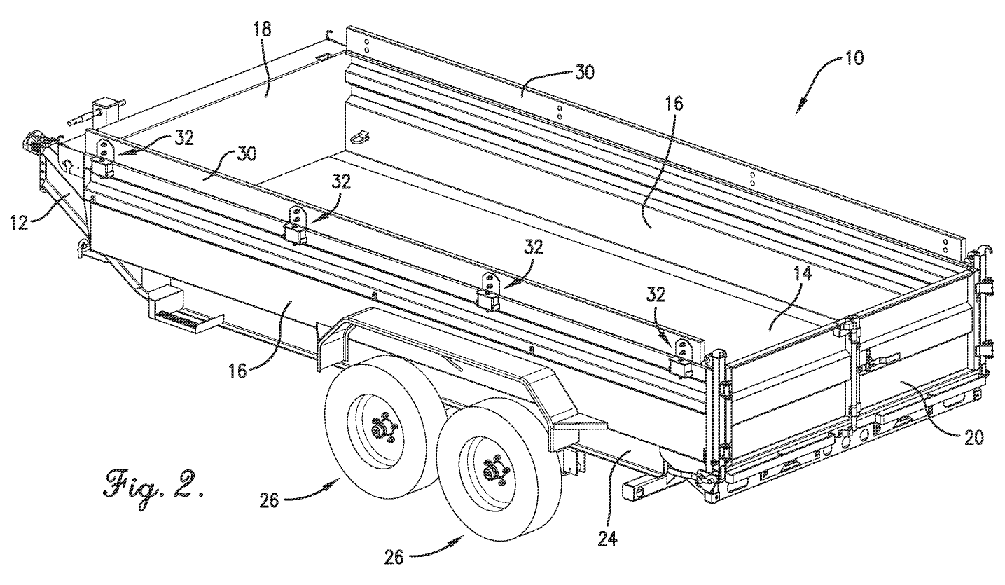

With reference to the figures, and particularly to FIGS. 1 and 2, embodiments of the present invention are broadly directed to a utility trailer 10 (referred to herein as the “trailer”), configured to be hitched to the rear of a motor vehicle (not shown) via a towbar 12. The trailer 10 may comprise a base 14, which may form a bed or deck for supporting a payload. A pair of side panels 16 may extend generally vertically upward from the base 14 on each lateral side of the trailer 10. In addition, the trailer 10 may include a front panel 18 that extends generally vertically upward from a front end of the base 14, such that the front panel 18 extends between front ends of the side panels 16. Furthermore, the trailer 10 may include a rear panel 20 that extends generally vertically upward from a rear end of the base 14, such that the rear panel 20 extends between rear ends of the side panels 16. As such, the base 14, the side panels 16, the front panel 18, and the rear panel 20 may define a cargo area within which a payload can be supported and maintained.

Relational and/or directional terms, such as “above”, “below”, “up”, “upper”, “upward”, “down”, “downward”, “lower”, “top”, “bottom”, “outer”, “inner”, “front”, “forward,” “back”, “rear”, “rearward”, etc., along with orientation terms, such as “horizontal” and “vertical”, may be used throughout this description. These terms retain their commonly accepted definitions and are used with reference to embodiments of the technology and the positions, directions, and orientations thereof shown in the accompanying figures. For example, with reference to FIG. 1, the front of the trailer 10 is shown in the lower left corner of the figure, while the rear of the trailer 10 is shown in the upper right corner of the figure. Embodiments of the technology may be positioned and oriented in other ways or move in other directions. Therefore, the terms do not limit the scope of the current technology.

The trailer 10 may include frame 24 on which the base 14, the side panels 16, the front panel 18, and the rear panel 20 are supported. In some embodiments, the frame 24 may be integrated with the towbar 12. Regardless, the trailer 10 may be supported on the ground by one or more pairs of wheels 26, with each wheel from a given pair of wheels 26 being connected via an axle. The axles may be attached to the frame 24 via a suspension system (e.g., a spring-type suspension system). The wheels may be provided with a protective wheel cover that is also connected to frame 24 and/or to the side panels 16. Although the trailer 10 illustrated in the drawings is a multi-axle trailer, with two axles, in alternative embodiments, the trailer 10 may be configured with more or fewer axles.

The towbar 12 extends forward from the rest of the trailer 10 and is configured to be attached to a vehicle for pulling the trailer 10. In some embodiments, the rear panel 20 of the trailer 10 may be rotatably secured to the base 14, to the side panels 16, and/or to the frame 24, such that the rear panel 20 functions as a gate to be opened and closed to provide access to the cargo space of the trailer 10. In some embodiments, the rear panel 20 can be rotated rearward and downward, such that a top end of the rear panel 20 can contact the floor or ground surface and the rear panel 20 can, thus, act as a ramp to facilitate loading and unloading of the payload within the cargo area of the trailer 10.

In some embodiments, it is preferable that a support element 30 be added to upper portions of the trailer 10 to enlarge the cargo area and to increase support for payload held within the cargo area. For example, as illustrated in FIGS. 1 and 2, such support elements 30 may comprise elongated pieces of wood, such as elongated two-by-fours secured to and/or adjacent to the top edges of the side panels 16. As will be described in more detail below, the support elements 30 may be secured to the trailer 10 via bracket assemblies 32 (see, e.g., FIGS. 1 and 2) that are removably mounted to the trailer 10. Regardless, it is contemplated that such bracket assemblies 32 may be used to secure support elements 30 of other sizes to the trailer 10, such as two-by-sixes, two-by-eights, two-by-tens, or even larger pieces of wood. Furthermore, it is contemplated that the support elements 30 secured to the trailer may be formed from non-wood materials, such as plastics, composites, metals, or the like.

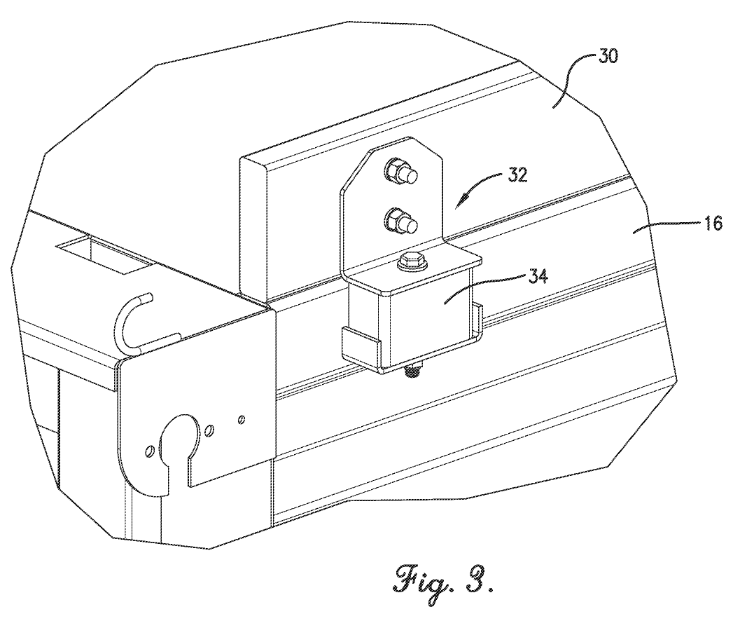

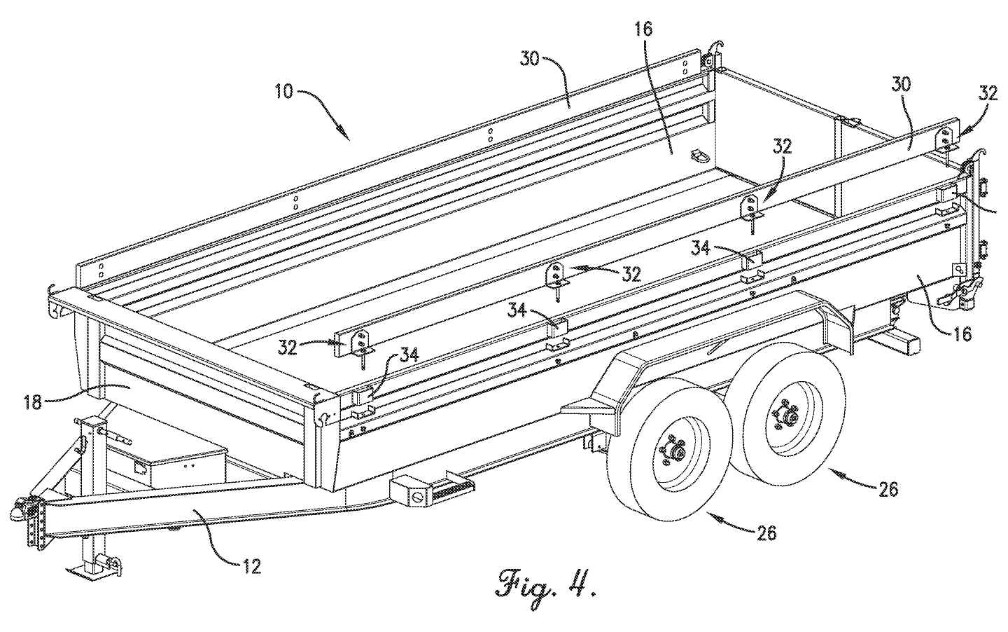

Turning to FIGS. 3-5, the bracket assemblies 32 may each be removably secured to the trailer 10 via a mount 34, which may be commonly referred to as a stake pocket. Each of the bracket assemblies 32 and/or the mounts 34 may be formed from materials having high strength and durability, such as steel or other metals. In some embodiments, the bracket assemblies 32 and/or the mounts 34 may be formed from the same type of material as the side panels 16 of the trailer 10, such as steel.

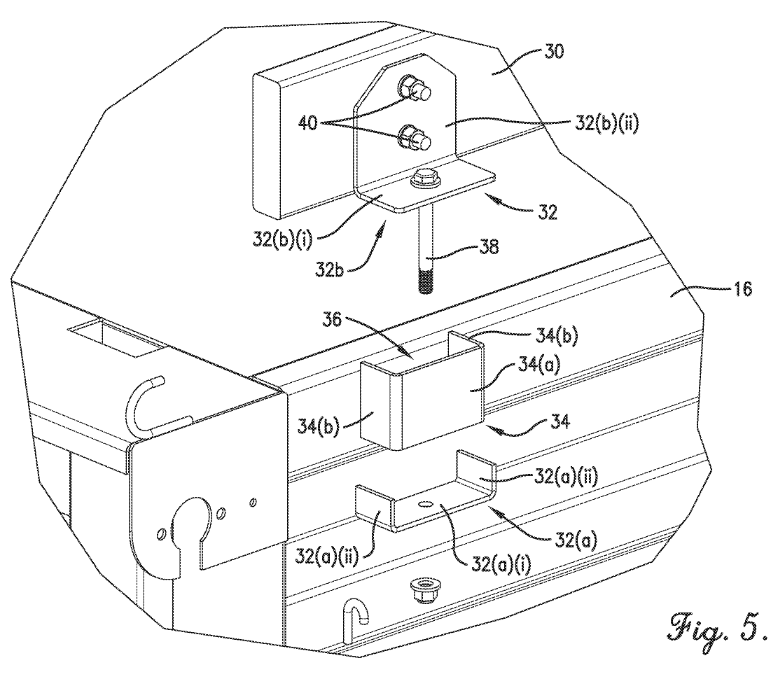

As perhaps best illustrated by FIG. 5, each mount 34 may comprise a section of c-channel that is secured to an exterior surface of a side panel 16 of the trailer 10, near a top of the side panel 16. Each mount 34 may comprise a main plate 34(a) that extends generally parallel to but spaced outward from the associated side panel 16. In addition, each mount 34 may include a pair of flange plates 34(b) that extend from forward and rearward ends of the main plate 34(a) to the associated side panel 16 (e.g., where the flange pates 34(b) are welded or otherwise rigidly secured to the side panels 16). The flange plates 34(b) may extend generally perpendicular with respect to the main plate 34(a) of the respective mount 34 and with respect to the associated side panel 16.

As such, each mount 16 presents a channel void 36 comprising a space between the mount 34 (e.g., between the main plate 34(a) and the flange plates 34(b)) and the exterior surface of the side panel 16. As illustrated by the figures, the trailer 10 may include a plurality of mounts 34 and, thus, a plurality of bracket assemblies 32 secured thereto. For example, in the illustrated embodiments, each side panel 16 may include four mounts 34 and four bracket assemblies 32 positioned at upper portions of the side panels 16. However, each side panel 16 may include more or fewer than four mounts 34 and/or four bracket assemblies 32, as may be required to mount one or more support elements 30 thereto. Regardless, support elements 30 may be mounted to top portions of each of the side panels 16 of the trailer 10, such that the support elements 30 extend upward from and/or adjacent to top edges of the side panels 16 along generally the entire lengths of the side panels 16. In addition, the front and rear panels 18, 20 may additionally include one or more mounts 34 and/or one or more bracket assemblies 32, such that support elements 30 may also be mounted to the trailer 10 on top portions of the front and rear panels 18, 20, such that the support elements 30 extend upward from and/or adjacent to top edges of the front and rear panels 18, 20, along generally the entire lengths of the front and rear panels 18, 20.

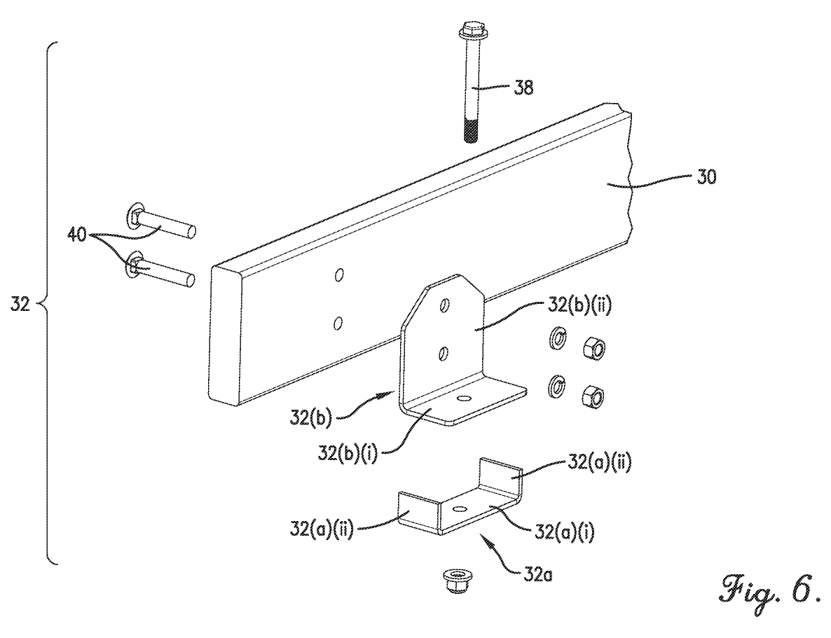

Turning to the bracket assemblies 32 in more detail, as perhaps best illustrated by FIGS. 5 and 6, the bracket assemblies 32 may each comprise a lower portion 32(a) and an upper portion 32(b) that may be distinct elements that are separable from each other. The lower portion 32(a) may comprise a section of c-channel material that is configured to be removably secured to a bottom of one of the mounts 34. Specifically, each lower portion 32(a) may comprise a main plate 32(a)(i) that (when mounted to the mount 34 as discussed in more detail below) extends generally horizontally, and may be oriented perpendicular to an associated side panel 16. In addition, each lower portion 32(a) may include a pair of flange plates 32(a)(ii) that extend upward (when mounted to the mount 34 as discussed in more detail below) from forward and rearward ends of the main plate 32(a)(i). The flange plates 32(a)(ii) may extend generally vertically, and may be oriented perpendicular to an associated side panel 16.

The upper portion 32(b) of each of the bracket assemblies 32 may comprise an L-shaped section of material with a main plate 32(b)(i) that (when mounted to the mount 34 as discussed in more detail below) extends generally horizontally, and may be oriented perpendicular to an associated side panel 16. In addition, each upper portion 32(b) may include a flange plate 32(b)(ii) that extends upward (when mounted to the mount 34 as discussed in more detail below) from an inward side of the main plate 32(b)(i). The flange plate 32(b)(ii) may extend generally vertically, and may be oriented parallel to an associated side panel 16.

In view of the above, a bracket assembly 32 may be mounted to a given mount 34 of a trailer in the following manner. First, the upper portion 32(b) of the bracket assembly 32 may be engaged with a top surface of one of the mounts 34. In general, the main plate 32(b)(i) should be sized sufficiently large that when the upper portion 32(b) is engaged with the mount 34, the main plate 32(b)(i) covers the entire top surface of the mount 34. In some embodiments, the main plate 32(b)(i) may be sufficiently sized to at least partially overhang the top surface of the mount 34 (see, e.g., FIG. 3). Next, the lower portion 32(a) of the bracket assembly 32 may be engaged with a bottom surface of the mount 34. In general, the main plate 32(a)(i) should be sized sufficiently large that when the lower portion 32(a) is engaged with the mount 34, the main plate 32(a)(i) covers the entire bottom surface of the mount 34. In addition, the lower portion 32(a) may at least partially overhang the bottom surface of the mount 34 via the flange plates 32(a)(ii) that each extends upward along and overlap exterior portions of the front and/or rear flange plates 34(b) of the mount 34 (see, e.g., FIG. 3 with the specific elements identified with reference numerals in FIG. 5).

The lower and upper portions 32(a), 32(b) of the bracket assembly 32 may be connected to each other in such a position and, thus, securely mounted to the respective mount 34, via a connection element 38. Although only one connection element 38 is shown in the figures, it should be understood that more or fewer than one connection element 38 may be used. The connection element 38 may comprise a fastener that extends through a through-hole formed in the main plate 32(b)(i) of the upper portion 32(b), through the channel void presented by the mount 34, and through a through-hole formed in the main plate 32(a)(i) of the lower portion 32(a) (see, e.g., FIGS. 3, 5, and 6). As shown in the figures, the fastener may extend through the through-hole in the in the main plate 32(b)(i) of the upper portion 32(b) such that the head of the fastener may engage with an upper surface of the main plate 32(b)(i). As a result, the body of the fastener extends generally vertically through the channel void presented by the mount 34, and a free end of the fastener extends though the through-hole formed in the main plate 32(a)(i) of the lower portion 32(a). A nut can be threaded onto the free end of the fastener (with the nut engaged with a lower surface of the main plate 32(a)(i)) to secure lower portion 32(a) in place.

The nut can be threaded/tightened as much as may be required onto the fastener to compress the lower and upper portions 32(a), 32(b) of the bracket assembly 32 together about the mount 34 to provide a clamping action to secure the bracket assembly 32 onto the mount 34. The length of the fastener can vary as may be required to permit a bracket assembly 32 to be secured to mounts of various heights. Correspondingly, the lengths and widths of the lower and upper portions 32(a), 32(b) may vary as needed to fit over mounts 34 of various sizes.

With a bracket assembly 32 removably secured to a mount 34, the bracket assembly 32 can be used to secure a support element 30 to the trailer 10. Specifically, the flange plate 32(b)(ii) of the upper portions 32(b) of the bracket assembly 32 may include a pair of through-holes extending throughout. Similarly, the support element 30 may include a pair of through-holes that correspond with the through-holes of the flange plate 32(b)(ii). When the through-holes of the support element 30 and the flange plate 32(b)(ii) are aligned (see, e.g., FIG. 6), a pair of connection elements 40, such as fasteners can be inserted through the aligned through-holes to secure the support element 30 to the bracket assembly 32. It is noted however, that more or fewer than two connection elements 40 may be used.

The fasteners may extend through the through-holes in the support element 30 such that the head of the fastener engages with an interior surface of the support element 30. In some embodiments, the fasteners may comprise carriage bolts, such that the heads of the bolts form a continuous, generally smooth surface with the interior surface the support element 30. As a result, payload items held within the cargo area of the trailer 10 will be prevented from being interfered with or damaged by the fasteners. As a result, the bodies of the fasteners extend generally horizontally through the support element 30, and free ends of the fasteners extend though the through-holes formed in the flange plate 32(b)(ii) of the upper portion 32(b) of the bracket assembly 32. Nuts can be threaded onto the free ends of the fasteners (with the nuts engaged with an exterior surface of the flange plate 32(b)(ii)) to secure support element 30 against the interior surface of the flange plate 32(b)(ii) of the upper portion 32(b) of the bracket assembly 32.

As illustrated in FIGS. 1 and 2, a support element 30 may be releasably secured to a left side panel 16 of the trailer 10 using four bracket assemblies 32 that are each releasably secured a respective mount 34. As such, each of the four bracket assemblies 32 may be releasably secured to an associated mount 34, and the support element 30 may be releasably secured to those four bracket assemblies 32, in the manner previously described above. However, as was previously noted, more or fewer than four bracket assemblies 32 and mounts 34 may be used on a given side of the trailer 10. Similarly, a support element 30 may be releasably secured to a right side panel 16 of the trailer 10 using four bracket assemblies 32 that are each releasably secured a respective mount 34. Furthermore, support elements 30 may also be releasably secured to the front and rear panels 18, 20 using bracket assemblies 32 that are releasably secured to mounts 34 located on the front and rear panels 18, 20. As such, one or more support elements 30 may also be secured around to portions of the side panels 16 (and/or to the front and rear panels 18, 20) to increase the cargo area of the trailer 10 and to provide improved ability to securely maintain payloads within the cargo area.

It should be understood that the above-described steps for securing support elements 30 to the trailer 10, via the bracket assemblies 32, may be performed using certain steps performed in different orders than those explicitly described. For example, it is contemplated that a support element 30 may be secured to the upper portions 32(b) of the bracket assemblies 32 before such bracket assemblies 32 are releasably secured to the mounts 30 of the trailer 10. Furthermore, it is also contemplated that some above-described steps could potentially be omitted, while other non-described steps may be included, all without departing from the spirit of the present invention.

Although the invention has been described with reference to the one or more embodiments illustrated in the figures, it is understood that equivalents may be employed and substitutions made herein without departing from the scope of the invention as recited in the claims. For example, although the above description and the accompanying drawings generally describe and illustrate a trailer in the form of a utility trailer with a side panel that extends upward from a base of the trailer, it is understood that embodiments of the present invention can include and/or be associated with various types of trailers. More broadly, embodiments of the present invention can include and/or may be used with generally any type of trailer with a side panel having one or more stake pockets attached thereto. For example, some embodiments of the present invention may include and/or be associated with a trailer in the form of a flatbed or a flatdeck trailer that includes side panels that form part of the frame of the trailer, but such side panels may not extend upward from a base or bed of the trailer. Nevertheless, such a flatbed trailer may include stake pockets attached to the side panels of the trailer, so that bracket assemblies may be mounted to the stake pockets and may be used to secure support elements around the sides or the perimeter of the flatbed trailer.

Having thus described one or more embodiments of the invention, what is claimed as new and desired to be protected by Letters Patent includes the following:

1. A trailer comprising:
a side panel;
a mount secured to the side panel, wherein the mount presents a channel void extending between the mount and the side panel; and
a bracket assembly removably secured to the mount, wherein the bracket assembly comprises a first portion and a second portion releasably connected together by a connection element,
wherein the bracket assembly is configured to permit a support element to be secured thereto such that the support element extends adjacent to a top of the side panel.

2. The trailer of claim 1, wherein the mount comprises a c-channel secured to an exterior surface of the side panel.

3. The trailer of claim 2, wherein the first portion of the bracket assembly is engaged with a top surface of the c-channel, wherein the second portion of the bracket assembly is engaged with a bottom surface of the c-channel, and wherein the connection element extends between the first and second portions of the bracket assembly and extends through the channel void.

4. The trailer of claim 3, wherein the second portion of the bracket assembly includes a pair of flange plates that each extend upward along an exterior surface of the c-channel.

5. The trailer of claim 3, wherein the first portion of the bracket assembly includes a flange plate extending upward from the c-channel, and wherein the flange plate of the bracket assembly is configured to permit the support element to be secure thereto.

6. The trailer of claim 5, wherein the flange plate is configured to permit the support element to be secured thereto via at least one connection element configured to extend through the support element and the flange plate.

7. The trailer of claim 6, wherein the at least one connection element comprises a carriage bolt.

8. The trailer of claim 1, wherein the trailer comprises more than one mount and more than one bracket assembly associated with the side panel, wherein each of the bracket assemblies is configured to permit the support element to be secured thereto such that the support element extends along a length of the side panel.

9. The trailer of claim 1, wherein the support element is an elongated piece of wood.

10. The trailer of claim 1, wherein the side panel is a first side panel, wherein the mount is a first mount, wherein the bracket assembly is a first bracket assembly, and wherein the trailer further includes:
a second side panel;
a second mount secured to an upper portion of the second side panel; and
a second bracket assembly removably secured to the second mount.

11. A bracket assembly for a trailer, said bracket assembly comprising:
a first portion comprising a base plate and a flange plate extending perpendicular to the base plate;
a second portion comprising a base plate and a pair of flange plates that extend from ends of the base plate perpendicular to the base plate;
a connection element configured to extend between and connect the first portion and the second portion,
wherein the flange element of the first portion of the bracket assembly is configured to permit a support element to be secured thereto.

12. The bracket assembly of claim 11, wherein the bracket assembly is configured to be secured to a mount of the trailer, with the first portion and the second portion of the bracket assembly clamping the mount by way of the connection element extending between the first portion and the second portion.

13. The bracket assembly of claim 12, wherein the first portion of the bracket assembly is configured to engage with a top surface of the mount, wherein the second portion of the bracket assembly is configured to engage with a bottom surface of the mount, and wherein the connection element extends between the first and second portions of the bracket assembly and extends through a channel void presented by the mount.

14. The bracket assembly of claim 13, wherein the pair of flange plates of the second portion are configured to extend upward along exterior surfaces of the mount.

15. The bracket assembly of claim 11, wherein the flange plate of the first portion is configured to permit the support element to be secured thereto via at least one connection element configured to extend through the support element and the flange plate.

16. The bracket assembly of claim 15, wherein the at least one connection element comprises a carriage bolt.

17. The bracket assembly of claim 11, wherein the support element is an elongated piece of wood.

18. A method of mounting a support element to a trailer, said method comprising the steps of:
(a) providing the trailer comprising a side panel and a mount secured to the side panel, wherein the mount presents a channel void extending between the mount and the side panel;
(b) removably securing a bracket assembly to the mount, wherein the bracket assembly comprises a first portion and a second portion releasably connected together by a connection element; and
(c) securing the support element to the bracket assembly such that the support element extends adjacent to an upper edge of the side panel.

19. The method of claim 18, wherein the mount is a first mount and the trailer includes a second mount secured to the side panel, wherein the bracket assembly is a first bracket assembly, and wherein the method further includes the steps of removably securing a second bracket assembly to the second mount and securing the support element to the second bracket assembly.

20. The method of claim 18, wherein the side panel is a first side panel and the trailer includes a second side panel, wherein the mount is a first mount and the trailer includes a second mount secured to the second side panel, wherein the bracket assembly is a first bracket assembly and the support element is a first support element, and wherein the method further includes the steps of removably securing a second bracket assembly to the second mount and securing a second support element to the second bracket assembly.
